(19) United States
(12) Patent Application Publication
(10) Pub. No.: US 2012/0032976 A1
(43) Pub. Date: Feb. 9, 2012

(54) IMAGE DISPLAY DEVICE, IMAGE DISPLAY SYSTEM, AND IMAGE DISPLAY METHOD

(76) Inventors: Takanori NAGAHARA, Kanagawa (JP); Katsuyuki Omura, Tokyo (JP)

(21) Appl. No.: 13/197,319

(22) Filed: Aug. 3, 2011

(30) Foreign Application Priority Data
Aug. 6, 2010 (JP) 2010-177166

(51) Int. Cl. G09G 5/377; G06F 3/041

(52) U.S. Cl. 345/629; 345/173

(57) ABSTRACT

An image display device refers to a database, in which at least one image frame to be displayed on a display unit and configuration information representing at least one drawn image to be superimposedly drawn on the at least one image frame are registered to be associated with each other, to judge whether or not an image frame identical to one of the at least one image frame received from an image frame provision device is present in the database, and causes the display unit to display at least one of the at least one drawn image represented by a part of the configuration information associated with an image frame judged as being identical to a received one of the at least one image frame.

### CROSS-REFERENCE TO RELATED APPLICATIONS

The present application claims priority to and incorporates by reference the entire contents of Japanese Patent Application No. 2010-177166 filed in Japan on Aug. 6, 2010.

### BACKGROUND OF THE INVENTION

1. Field of the Invention

The present invention relates to an image display device that displays an arbitrary image on a display screen, and more particularly, to an image display device, an image display system, and an image display method in which an image drawn by a user on a display screen is displayed.

2. Description of the Related Art

Conventionally, at conferences or the like in companies, educational institutions, administrative agencies, and the like, an electronic blackboard is being used which displays a background image on a large-scaled display and allows a user to write a drawn image such as letters, numerical numbers, diagrams, or the like on the background image.

Currently, Smart Board available from Smart Technologies Co., Ltd., Star Board (a registered trademark) available from Hitachi Software Engineering Co., Ltd., Cyber Conference (a registered trademark) available from Pioneer Corporation, and the like are being provided as electronic blackboards. Japanese Patent Application Laid-open No. 2008-176802 discloses an electronic blackboard system including a coordinate input/detection device. These electronic blackboards have a function of displaying a background image functioning as a blackboard on a screen and displaying a drawn image drawn with a touch panel on the screen in a superimposed manner.

### SUMMARY OF THE INVENTION

It is an object of the present invention to at least partially solve the problems in the conventional technology.

According to an aspect of the present invention, there is provided an image display device that displays at lease one image frame, including: a receiving unit that receives the at least one image frame from an image frame provision device that provides the at least one image frame; a display unit that displays one of the at least one image frame that is received by the receiving unit; a touch panel that detects a contact position on the display unit, which configures configuration information of at least one drawn image to be superimposedly drawn on the at lease one image frame; a database in which the at least one image frame and the configuration information of the at least one drawn image to be displayed on the display unit are registered to be associated with each other; a judging unit that refers to the database to judge whether or not an image frame that is identical to one of the at least one image frame received from the image frame provision device is present in the database. The judging unit refers to the database to cause the display unit to display at least one of the at least one drawn image represented by a part of the configuration information associated with an image frame judged as being identical to a received one of the at least one image frame.

According to another aspect of the present invention, there is provided an image display system, including: an image display device that displays at least one image frame; and an image frame provision device that provides the image display device with the at least one image frame. The image display device includes a receiving unit that receives the at least one image frame from the image frame provision device, a display unit that displays one of the at least one image frame that is received by the receiving unit, a touch panel that detects a contact position on the display unit, which configures configuration information of at least one drawn image to be superimposedly drawn on the at lease one image frame, a database in which the at least one image frame and the configuration information of the at least one drawn image to be displayed on the display unit are registered to be associated with each other, and a judging unit that refers to the database to judge whether or not an image frame identical to one of the at least one image frame received from the image frame provision device is present in the database. The judging unit refers to the database to cause the display unit to display at least one of the at least one drawn image represented by a part of the configuration information associated with an image frame judged as being identical to a received one of the at least one image frame.

According to still another aspect of the present invention, there is provided an image display method executed by an image display device that displays at least one image frame, including: receiving, by the image display device, the at least one image frame from an image frame provision device that provides the at least one image frame; and judging, by the image display device, whether or not there is an image frame identical to one of the at least one image frame received from the image frame provision device by referring to a database in which the at least one image frame to be displayed on a display unit of the image display device and configuration information of at least one drawn image to be superimposedly drawn on the at least one image frame are registered to be associated with each other. The judging includes referring to the database to cause the display unit to display at least one of the at least one drawn image represented by a part of the configuration information associated with an image frame judged as being identical to a received one of the at least one image frame.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an image display system according to an embodiment;

FIG. 2 is a diagram illustrating a functional configuration of an image display device according to the embodiment;

FIG. 3 is a flowchart illustrating a process executed by an image display device according to the embodiment;

FIG. 4 is a diagram illustrating a use state of the image display device according to the embodiment;

FIG. 5 is a diagram illustrating a snapshot history information table used by the image display device according to the embodiment;

FIG. 6 is a diagram illustrating a functional configuration of an image display device according to another embodiment;

FIG. 7 is a flowchart illustrating a process executed by the image display device according to another embodiment;

FIG. 8 is a flowchart illustrating a process executed by the image display device according to another embodiment; and

FIG. 9 is a diagram illustrating an embodiment of an image frame displayed on an image display device.

### DETAILED DESCRIPTION OF THE PREFERRED EMBODIMENTS

Hereinafter, embodiments of the present invention will be described, but the present invention is not limited to the following embodiments.

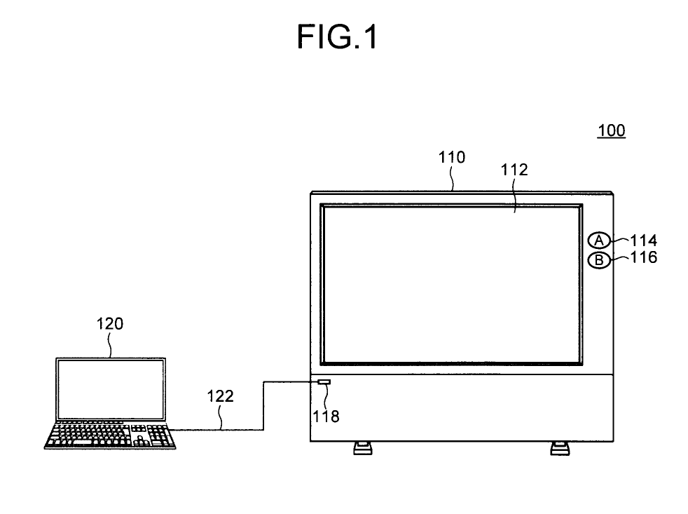

FIG. 1 illustrates an image display system 100 according to an embodiment. The image display system 100 includes an image display device 110 and a user personal computer (PC) 120.

The image display device 110 is a device that displays an image frame that is a background image received from the user PC 120, and displays a drawn image drawn by a user. The image display device 110 is configured to include a display unit 112, operation buttons 114 and 116, and an image frame input unit 118.

The display unit 112 is a functional unit that displays the background image and the drawn image. The display unit 112 includes a touch panel installed on a screen thereof and can detect the user's contact position with a contact position sensor that configures the touch panel.

The operation buttons 114 and 116 are a functional unit used to instruct switching of an operation mode of the image display device 110. Switching of the operation mode of the image display device 110 will be described later in detail.

The image frame input unit 118 is a functional unit that receives the image frame, which is a background image displayed on the display unit 112, from the user PC 120. In the present embodiment, a video graphic array (VGA) input connector configured by a VGA terminal may be employed as the image frame input unit 118. In this case, a VGA signal is received from the user PC 120 through a cable 122 such as a VGA cable, and the VGA signal is supplied to a controller (not shown) included in the image display device 110. In another embodiment, the image frame input unit 118 may receive image data from the user PC 120 through a radio communication that conforms to a radio communication protocol such as Bluetooth or WiFi.

The image display device 110 includes a Pentium (a registered trademark) processor or a compatible processor and executes a program of the present invention written in a program language such as assembler, C, C++, Java (a registered trademark), JavaScript (a registered trademark), Perl, Ruby, and Python under the management of an operating system (OS) such as Windows (a registered trademark) series, Unix (a registered trademark), Linux (a registered trademark), Itron, or μItron. The image display device 110 includes a random access memory (RAM) that provides an execution space used to execute the program of the present invention and a hard disk drive (HDD) device used to persistently retain a program, data, and the like. By executing the program of the present invention, each functional unit of the present embodiment is implemented in the image display device.

The program of the present invention may be distributed in the form stored in a device-readable recording medium such as a HDD, a compact disc-read only memory (CD-ROM), a magneto optical (MO), a flexible disk, an electrically erasable programmable read-only memory (EEPROM), and an erasable programmable read-only memory (EPROM). The program of the present invention may be configured in a form readably by foreign device and transmitted via a network.

The user PC 120 is an image frame provision device that provides the image display device 110 with the image frame which is the background image. In the embodiment illustrated in FIG. 1, a notebook computer is employed as the user PC 120, but in another embodiment, an information processing device, which can supply image data, such as a desktop type PC, a personal digital assistant (PDA) may be used. The user PC 120 includes an interface, which serves to output the background image, and supplies a display image being displayed on a display screen thereof to the image display device 110. In the present embodiment, the user PC 120 includes a VGA output connector as the interface and can supply the image display device 110 with the display image as a VGA signal. In another embodiment, the user PC 120 may transmit the display image through a radio communication that conforms to a variety of radio communication protocols.

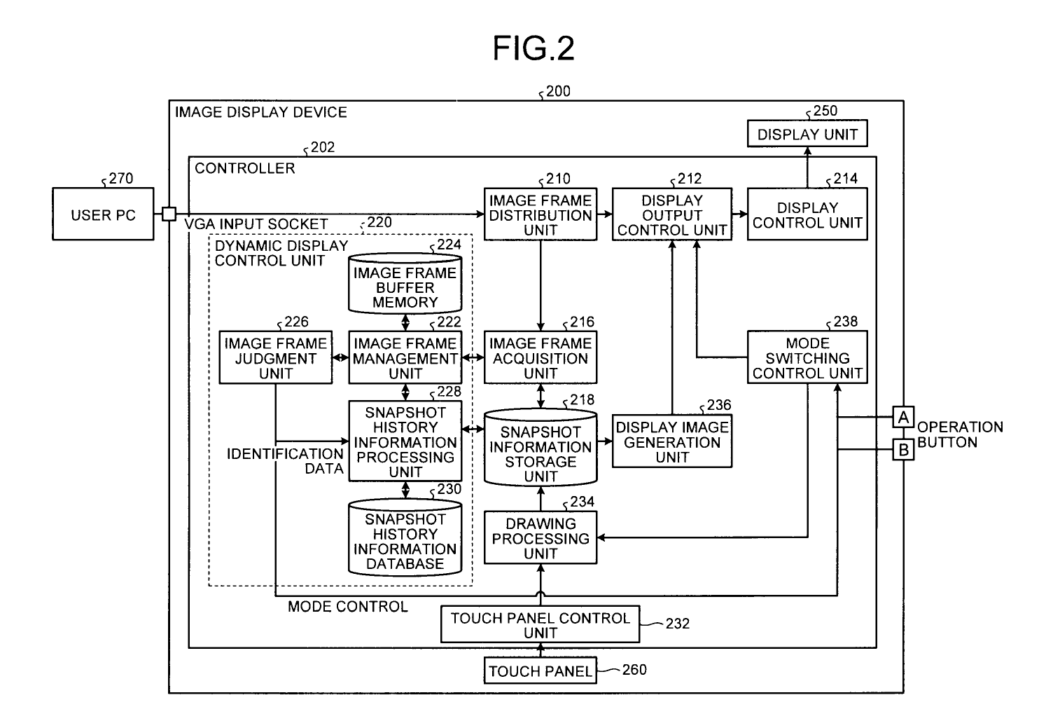

FIG. 2 is a diagram illustrating a functional configuration of an image display device 200 according to the present embodiment. The functional configuration of the image display device 200 will be described below with reference to FIG. 2.

The image display device 200 is configured to include a controller 202, a display unit 250, and a touch panel 260. The controller 202 is a functional unit that processes the background image received from a user PC 270 and the drawn image input through the touch panel 260. The controller 202 is configured to include an image frame distribution unit 210, a display output control unit 212, and a display control unit 214.

The image frame distribution unit 210 is a functional unit that acquires the image frame, which is to be displayed on the display unit 250, received from the user PC 270 and distributes the image frame to the display output control unit 212 or an image frame acquisition unit 216. In the present embodiment, the image frame distribution unit 210 distributes the image frame, which is configured by an analogue signal such as the VGA signal, according to an operation mode which can be designated by the operation button. Specifically, when an operation mode of the image display device 200 is an image frame display mode which is a first state, the image frame distribution unit 210 provides the display output control unit 212 with the image frame. Meanwhile, when a drawn image display mode which is a second state is designated, the image frame distribution unit 210 provides the image frame acquisition unit 216 with the image frame.

The display output control unit 212 is a function unit that selectively outputs an image to the display control unit 214 in response to a request by a mode switching control unit 238. In the present embodiment, the display output control unit 212 may be configured with a two-input one-output toggle operation switch circuit. In the image frame display mode which is the first state, the display output control unit 212 provides the display control unit 214 with the image frame received from the image frame distribution unit 210. When the drawn image display mode which is the second state is designated, the display output control unit 212 provides the display control unit 214 with an image received from a display image generation unit 236.

The display control unit 214 is a functional unit that causes display of an image received from the display output control unit 212 on the display unit 250. The display control unit 214 transmits an analogue signal configuring the image received from the display output control unit 212 to the display unit 250 to cause the display unit 250 to display the image.

Further, the controller 202 is configured to include the image frame acquisition unit 216, a snapshot information storage unit 218, and a dynamic display control unit 220.

The image frame acquisition unit 216 is a functional unit that sequentially stores the image frames acquired from the image frame distribution unit 210 in the snapshot information storage unit 218 when the drawn image display mode, which is the second state, is designated. The image frame acquisition unit 216 performs analogue-to-digital (A/D) conversion to convert the image frame configured by the analogue signal such as the VGA signal into a digital image frame and then stores the digital image frame in the snapshot information storage unit 218. Further, the image frame acquisition unit 216 acquires the image frame from the snapshot information storage unit 218 and provides the acquired image frame in response to a request by another functional unit.

The snapshot information storage unit 218 is a storing unit that stores a last image frame and information configuring last one of the drawn images (hereinafter, referred to as “drawn image configuration information”) that configure snapshot information of the image frame and the drawn image. In the snapshot information storage unit 218, latest image frames, which are to be displayed on the display unit 250, received from the user PC 270 are sequentially stored. Further, in the snapshot information storage unit 218, stored is latest piece of the drawn image configuration information denoting latest drawn image which the user has drawn through the touch panel using a drawing processing unit which will be described later.

The dynamic display control unit 220 is a functional unit that associates the image frame, which is being displayed on the display unit 250, with the drawn image, which have been drawn by the user on the display unit 250 using the touch panel 260, when the drawing image display mode which is the second state is designated. The dynamic display control unit 220 is configured to include an image frame management unit 222, an image frame buffer memory 224, an image frame judgment unit 226, a snapshot history information processing unit 228, and a snapshot history information database 230.

The image frame management unit 222 is a functional unit that acquires the image frame received from the user PC 270; and provides the acquired image frame in response to a request by another functional unit included in the dynamic display control unit 220 or stores the acquired image frame in the image frame buffer memory 224. The image frame management unit 222 periodically issues a load request to the image frame acquisition unit 216 to acquire the latest image frame stored in the snapshot information storage unit 218; and temporarily stores the acquired latest image frame in a storage device (not shown) such as a RAM or a register. The image frame management unit 222 generates image frame identification information which is information for uniquely identifying the image frame acquired from the snapshot information storage unit 218. In the present embodiment, the image frame is acquired at intervals of 1/30 seconds, but in another embodiment, the image frame may be acquired at arbitrary intervals.

The image frame buffer memory 224 is a storing unit that stores therein the image frame which the image frame management unit 222 has acquired from the snapshot information storage unit 218. The image frames periodically acquired from the snapshot information storage unit 218 are sequentially stored in the image frame buffer memory 224.

The image frame judgment unit 226 is a functional unit that judges the identity between two consecutive image frames acquired from the image frame acquisition unit 216 are identical to each other. That is, the image frame judgment unit 226 judges whether or not a new the image frame has been received from the user PC 270.

In the present embodiment, the image frame judgment unit 226 sets one or more specific area included in each of the image frames as a reference area and compares images in the reference areas each included in one of the two image frames. When the images in the reference areas are identical to each other as a result of comparison, it is judged that the two image frames are identical to each other, whereas when the images in the reference areas are different from each other, it is judged that the image frames are different from each other. In the case of comparing the images in the reference areas, the image frame judgment unit 226 may judge whether or not the images in the reference areas are identical to each other by calculating the value of the sum of pixel values in each of the reference areas of the two image frames and compares the values of the sums of the pixel values in the reference areas corresponding to each other. An integrated image in the reference area may be used for calculating the value of the sum of the pixel values of the reference area.

In the present embodiment, the identity between the image frames may be judged using the following Equation (1). Here, Rk represents a sum value of pixel values in a reference area k of a first image frame, and Sk represents a sum value of pixel values in a reference area k in a second image frame. N represents the number of reference areas.

$${\sum }_{k = 0}^{N} ( {R}_{k} - {S}_{k} ) = 0 \qquad ( 1 )$$

When the condition of Equation (1) is satisfied, it can be judged that the first image frame is identical to the second image frame.

In another embodiment, the image frame judgment unit 226 may judge whether or not the image frames are identical to each other by calculating sum values of all pixel values of two image frames.

When it is judged that the two consecutive image frames are different from each other as a result of the abovementioned judgment process, the image frame judgment unit 226 notifies the snapshot history information processing unit 228 of the fact that a new image frame has been received from the user PC 270.

The snapshot history information processing unit 228 is a functional unit that registers the image frame received from the user PC 270 in a snapshot history information table in the snapshot history information database 230 so that the image frame is associated with the drawn image. When the image frame judgment unit 226 judges that the new image frame has been received from the user PC 270, the snapshot history information processing unit 228 acquires the latest drawn image configuration information from the snapshot information storage unit 218 and stores the drawn image configuration information in the snapshot history information table so that the drawn image configuration information is associated with the image frame acquired by the image frame management unit 222.

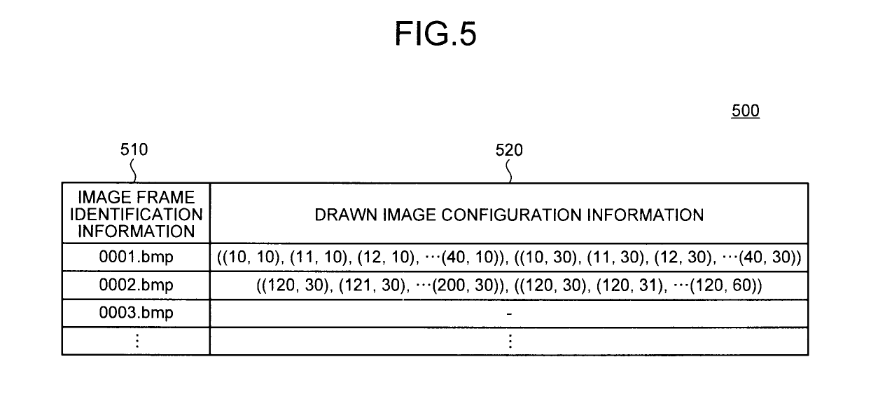

The snapshot history information database 230 is a storing unit that stores the snapshot history information table in which the snapshot history information which is history information of snapshot information is registered. The snapshot history information database 230 updates the data contents of the snapshot history information table in response to a request by the snapshot history information processing unit 228. The snapshot history information table will be described later with reference to FIG. 5 together with information to register.

Further, the controller 202 includes a touch panel control unit 232, the drawing processing unit 234, the display image generation unit 236, and the mode switching control unit 238.

The touch panel control unit 232 is a functional unit that controls the touch panel 260 and acquires the drawn image configuration information. When the drawn image display mode which is the second state is designated, the touch panel control unit 232 drives the touch panel 260, acquires contact position coordinates, and provides the drawing processing unit 234 with the acquired contact position coordinates.

In the present embodiment, a device driver which can control the touch panel 260 may be employed as the touch panel control unit 232. The touch panel control unit 232 can display, on the display unit 250, a user interface through which drawn image attribute information such as the thickness or the color of line segments configuring the drawn image can be designated. Further, the touch panel control unit 232 can provide the drawing processing unit 234 with the drawn image attribute information as the drawn image configuration information.

The drawing processing unit 234 is a functional unit that stores the drawn image configuration information in the snapshot information storage unit 218 when the drawn image display mode which is the second state is designated. When the drawn image configuration information is received from the touch panel control unit 232, the drawing processing unit 234 sequentially stores the drawn image configuration information in the snapshot information storage unit 218. As a result, the latest drawn image configuration information is stored in the snapshot information storage unit 218.

The display image generation unit 236 is a functional unit that generates a display image which is an image to be displayed on the display unit 250 when the drawn image display mode which is the second state is designated. The display image generation unit 236 periodically acquires the latest image frame and the latest drawn image configuration information from the snapshot information storage unit 218; generates the drawn image based on the drawn image configuration information; synthesizes the drawn image with the image frame; converts the synthesized image into an analog signal; and generates the display image.

In further detail, the display image generation unit 236 may generate the drawn image on the latest image frame by changing a pixel value at a coordinate position denoted by each contact position coordinates included in the drawn image configuration information to a pixel value according to the color denoted by the drawn image attribute information. Further, when the thickness of a line segment is designated, the drawn image may be generated by changing pixel values in a predetermined range centering on the coordinate position denoted by the contact position coordinates to a pixel value according to the color denoted by the drawn image attribute information. The predetermined range may be set in advance as a function of the thickness of a line segment. The display image generation unit 236 provides the display output control unit 212 with the display image generated in this way, so the display image is displayed on the display unit 250.

In the present embodiment, the display image generation unit 236 preferably generates the display image and displays the display image on the display unit 250 at an interval equal to or shorter than an interval at which the image frame management unit 222 acquires the image frame.

The mode switching control unit 238 is a functional unit that performs control of switching between the operation modes of the image display device 200. The mode switching control unit 238 switches the operation mode according to a type of an operation button pressed by the user or in response to a command from the image frame judgment unit 226. In the present embodiment, when an operation button “A” is pressed down, the mode switching control unit 238 switches the operation mode of the image display device 200 to the image frame display mode which is the first state. Further, when an operation button “B” is pressed down, the mode switching control unit 238 switches the operation mode of the image display device 200 to the drawn image display mode which is the second state.

Specifically, the mode switching control unit 238 transmits to the display output control unit 212 a command to switch an input terminal receiving an image to be displayed so as to cause the display output control unit 212 to switch the input terminal. Further, the mode switching control unit 238 transmits a command to enable or disable an operation of the drawing processing unit 234 to the drawing processing unit 234 so as to enable or disable the operation of the drawing processing unit 234.

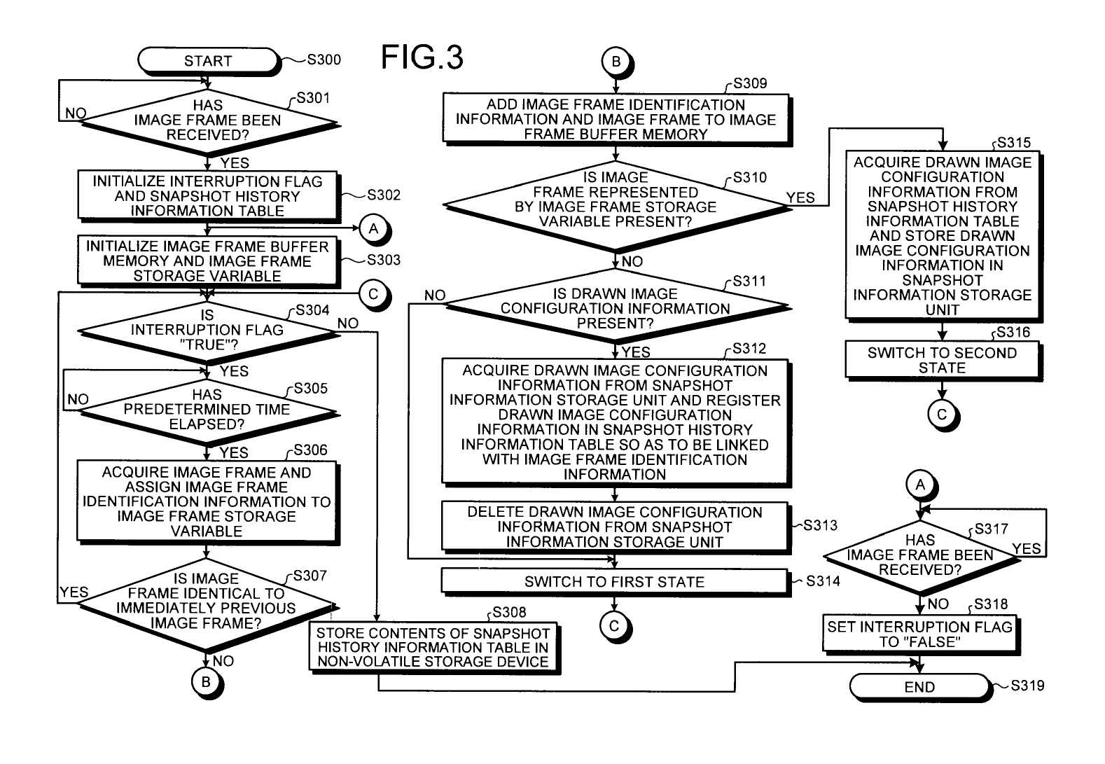

FIG. 3 is a flowchart illustrating a process executed by an image display device according to the present embodiment when the drawn image display mode which is the second state is designated. Referring to FIG. 3, in Step S300, the process starts; and in Step S301, the image frame management unit 222 judges whether or not the image frame has been received from the user PC 270. In the present embodiment, the presence and absence of reception of the image frame may be judged such that when the image frame acquisition unit 216 receives the image frame, the image frame acquisition unit 216 changes a value of a dedicated register representing the presence and absence of acquisition of the image frame to a value representing the fact that the image frame has been received, and the image frame acquisition unit 216 refers to the value of the dedicated register. Further, when the image frame has not been received during a predetermined time period, the image frame acquisition unit 216 changes the value of the dedicated register to a value representing the fact that the image frame has not been received.

When it is judged that the image frame has not been received (No in Step S301), the process of Step S301 is repeated. However, the process branches to Step S302 when it is judged that the image frame has been received (Yes in Step S301). In Step S302, the snapshot history information processing unit 228 initializes the snapshot history information table in the snapshot history information database 230 and an interruption flag representing the presence and absence of the image frame. In the present embodiment, the interruption flag is initialized such that it is set to a value representing that the image frame is present. In the present embodiment, “true” is used as an initial value.

When the process of Step S302 is executed, a process of Step S303 and a process of Step S317 are subsequently executed.

In Step S317, the image frame management unit 222 judges whether or not another image frame has been received from the user PC 270. When it is judged that another image frame has been received (Yes in Step S317), the process of Step S317 is repeated. However, the process branches to Step S318 when it is judged that another image frame has not been received (No in Step S317). In Step S318, the interruption flag is set to a value representing that an image frame has not been received. Then, in Step S319, the process is finished. In the present embodiment, “False” is used as the value representing that an image frame has not been received.

In Step S303, the image frame management unit 222 initializes the image frame buffer memory 224 and an image fame storage variable to be assigned the image frame identification information of the image frame stored in the image frame buffer memory 224. In Step S304, the image frame management unit 222 judges whether or not the interruption flag has the initial value “true,” that is, whether or not the image frame has been received. When it is judged that the interruption flag does not have the initial value “true” (No in Step S304), the process branches to Step S308. In Step S308, the snapshot history information processing unit 228 stores the contents of the snapshot history information table stored in the snapshot history information database 230 in a non-volatile storage device, for example, as a log or a journal. Then, in Step S319, the process is finished.

Meanwhile, when it is judged that the interruption flag has the initial value “true” (Yes in Step S304), the process branches to Step S305. In Step S305, the image frame management unit 222 judges whether or not a predetermined time has elapsed. When it is judged that the predetermined time has not elapsed (No in Step S305), the process of Step S305 is repeated. However, the process branches to Step S306 when it is judged that the predetermined time has elapsed (Yes in Step S305).

In the present embodiment, time may be measured using a hardware timer or a software timer. For example, when it is judged in Step S304 that the interruption flag has the initial value “true”, a timer starts to measure time; and, in Step S305, it may be judged whether or not a predetermined time (for example, 1/30 seconds) has elapsed by acquiring a measured time from the timer.

In Step S306, the image frame management unit 222 acquires the latest image frame from the snapshot information storage unit 218 through the image frame acquisition unit 216 and assigns the image frame identification information of the latest image frame to the image frame storage variable. In Step S307, the image frame judgment unit 226 judges whether or not a lastly stored image frame (hereinafter, referred to as “immediately previous image frame) among image frames already stored in the image frame buffer memory 224 is identical to an image frame denoted by the image frame identification information assigned to the image frame storage variable in Step S306. When it is judged that the image frames are identical to each other in the judgment in Step 307 (Yes in Step S307), the process branches to Step S304. However, when it is judged that the image frames are different from each other (No in Step S307), the process branches to Step S309.

In Step S309, the image frame judgment unit 226 adds the image frame identification information designated by the image frame storage variable and the image frame denoted by the image frame identification information to the image frame buffer memory 224 through the image frame management unit 222. In Step S310, the snapshot history information processing unit 228 refers to the snapshot history information table in the snapshot history information database 230 to judge whether or not the image frame is present which is identical to the latest image frame denoted by the image frame identification information assigned to the image frame storage variable.

In the present embodiment, the snapshot history information processing unit 228 may employ a method of judging the identity between the image frames as that executed by the image frame judgment unit 226. The snapshot history information processing unit 228 sequentially acquires the image frame denoted by the image frame identification information registered in the snapshot history information table from the image frame buffer memory 224 and compares the acquired image frame with the latest image frame using the method. Further, in another embodiment, the snapshot history information processing unit 228 may cause the image frame judgment unit 226 to judge the identity between the image frames. In this case, the image frame judgment unit 226 sequentially acquires the image frame denoted by the image frame identification information registered in the snapshot history information table from the image frame buffer memory 224 and compares the acquired image frame with the latest image frame.

Meanwhile, when it is judged that the image frame identical to the image frame designated by the image frame storage variable is not present (No in Step S310), the process branches to Step S311. In Step S311, the snapshot history information processing unit 228 judges whether or not the drawn image configuration information is stored in the snapshot information storage unit 218. When it is judged that the drawn image configuration information is not stored (No in Step S311), the process branches to Step S314. However, when it is judged that the drawn image configuration information is stored (Yes in Step S311), the process branches to Step S312.

In Step S312, the snapshot history information processing unit 228 acquires the latest drawn image configuration information from the snapshot information storage unit 218 and registers the acquired latest drawn image configuration information in the snapshot history information table so that the acquired latest drawn image configuration information is associated with the image frame identification information designated by the image frame storage variable. In Step S313, the snapshot history information processing unit 228 deletes the drawn image configuration information stored in the snapshot information storage unit 218.

In Step S314, the snapshot history information processing unit 228 transmits to the mode switching control unit 238 a command to switch the operation mode of the image display device to the first state, so that the mode switching control unit 238 switches the operation mode. When the process of Step S314 is finished, the process of Step S304 is executed.

Meanwhile, when it is judged that the image frame identical to the image frame designated by the image frame storage variable is present (Yes in Step S310), the process branches to Step S315. In Step S315, the snapshot history information processing unit 228 acquires the drawn image configuration information associated with the image frame judged as being identical in Step S310 by referring to the snapshot history information table, and stores the acquired drawn image configuration information in the snapshot information storage unit 218. Thus, when the background image previously displayed on the image display device is displayed again, the drawn image associated with the background image can be displayed again together with the background image.

In Step S316, the snapshot history information processing unit 228 transmits to the mode switching control unit 238 a command to switch the operation mode of the image display device to the second state, so that the mode switching control unit 238 switches the operation mode. When the process of Step S316 is finished, the process of Step S304 is executed.

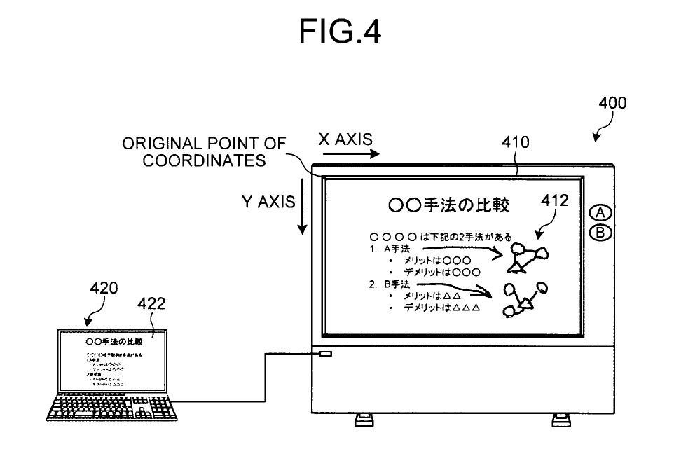

FIG. 4 is a diagram illustrating a use state of an image display device according to the present embodiment. On a display unit of an image display device 400, an image frame 410 which is identical to an image frame 422 displayed on a PC 420 and a drawn image 412 drawn by a user are displayed in a superimposed manner. In the present embodiment, contact position coordinates related to the drawn image 412 are given using a coordinate value for which a top left point of the display unit of the image display device 400 is used as an original point.

FIG. 5 illustrates a snapshot history information table 500 used by the image display device according to the present embodiment. In the snapshot history information table 500, image frame identification information 510 and drawn image configuration information 520 are registered to be associated with each other.

The image frame identification information 510 is information for uniquely identifying the image frame received by the image display device. In an embodiment illustrated in FIG. 5, a combination of a digit string and a character string representing a storage type of an image frame is used as the image frame identification information. However, in another embodiment, a different digit string, a different character string, and/or a combination thereof may be used.

The drawn image configuration information 520 is information that configures the drawn image which the user has drawn using the touch panel. The drawn image configuration information 520 includes information representing the position at which the user touches the touch panel. The drawn image configuration information 520 can be represented by a coordinate value on the display unit of the image display device. In the embodiment illustrated in FIG. 5, only the coordinate value denoting a position at which the drawn image should be displayed is illustrated as the drawn image configuration information. However, in another embodiment, in addition to the coordinate value, attribute information of the drawn image such as the display color or the thickness of a line segment of the drawn image may be registered such that the attribute information is associated with the image frame identification information.

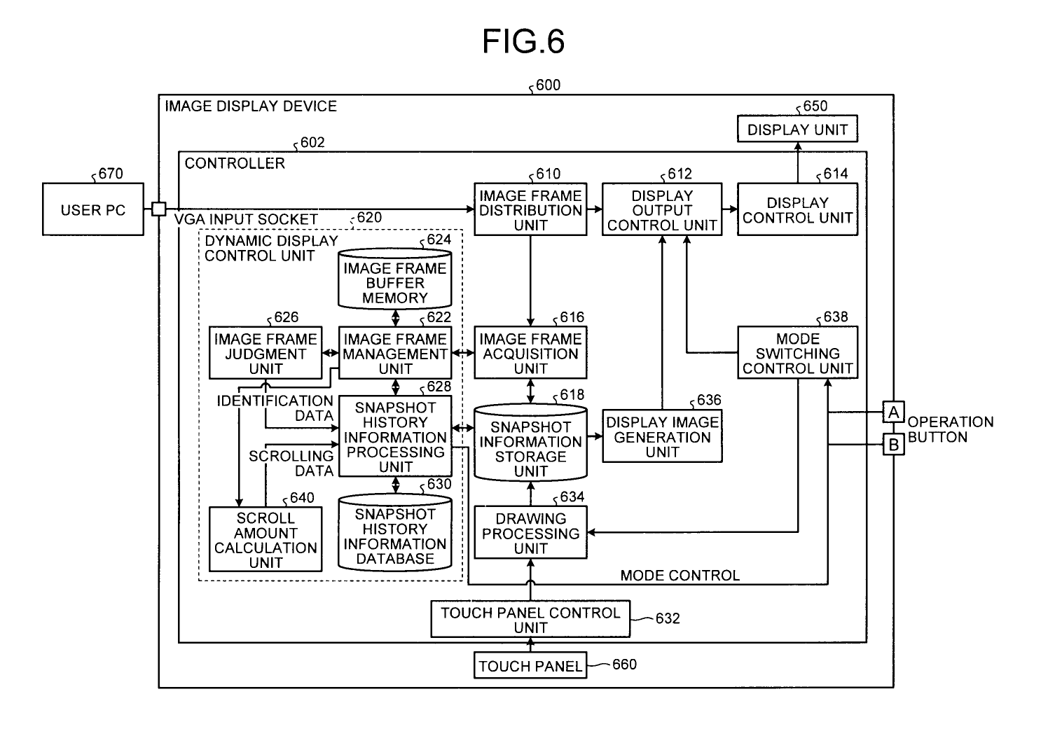

FIG. 6 is a diagram illustrating a functional configuration of an image display device 600 according to another embodiment. The function configuration of the image display device 600 will be described below with reference to FIG. 6. A redundant description regarding a functional unit having the same function as the functional unit of the image display device 200 illustrated in FIG. 2 will not be repeated.

In the embodiment illustrated in FIG. 6, a dynamic display control unit 620 is configured to include an image frame management unit 622, an image frame buffer memory 624, an image frame judgment unit 626, a snapshot history information processing unit 628, a snapshot history information database 630, and a scroll amount calculation unit 640.

The scroll amount calculation unit 640 is a functional unit that calculates a scroll amount which is a movement amount when the image frame received from a user PC 670 has moved by scrolling. The scroll amount calculation unit 640 calculates an amount of scrolling in a horizontal direction or a vertical direction performed between two consecutive image frames acquired by the image frame management unit 622. Specifically, the scroll amount calculation unit 640 calculates the scroll amount as follows:

(1) values of pixels each configuring one of two consecutive image frames are compared in units of one pixel or in units of a group of pixels, and a difference therebetween is calculated;

(2) an area obtained by excluding an area corresponding to a pixel with no difference between the image frames from each image frame is specified as a scroll area of each image frame;

(3) on the scroll area of each image frame, a reference area used to calculate the scroll amount is specified; and

(4) the identity between the reference areas of the image frames is judged by comparing the reference areas of the image frames, and a movement amount in a horizontal direction and/or a vertical direction between the reference areas judged as identical to each other is calculated as the scroll amount of the image frame.

In the process (3), when the scroll amount of the image frame in the vertical direction is calculated, the reference area is specified such that the scroll area is divided into a plurality of sub scroll areas in the vertical direction, and a sub scroll area other than a sub scroll area whose entire area is blank among the sub scroll areas is set as the reference area. Meanwhile, when the scroll amount of the image frame in the horizontal direction is calculated, the reference area is specified such that the scroll area is divided into a plurality of sub scroll areas in the horizontal direction, and a sub scroll area other than the sub scroll area whose entire area is blank among the sub scroll areas is set as the reference area.

In the process (4), whether or not one reference area of the latest image frame is identical to any one of reference areas of the immediately previous image frame is judged using a pattern recognition method such as template matching. When the reference areas identical to each other are present, the scroll amount is calculated by comparing coordinate values of the reference positions of the reference areas (for example, coordinate values of top left points of the reference areas). Further, it is judged whether or not there is any other reference area of the latest image frame which is identical to any one of reference areas of the immediately previous image frame. When there is any other identical reference area, the scroll amount can be calculated using coordinate value of the reference position of the reference area.

In the present embodiment, an average value of the movement amounts of the reference areas judged as being identical may be calculated as the scroll amount of the image frame using the following Equation (2). Here, Rxk represents an x coordinate value of a top left point of a reference area k of a first image frame, and Ryk represents a y coordinate value of the top left point of the reference area k of the first image frame. Sxk represents an x coordinate value of a top left point of a reference area k of a second image frame; and Syk represents a y coordinate value of the top left point of the reference area k of the second image frame. Further, N represents the number of reference areas which are judged as being identical between the first image frame and the second image frame.

$$Δ x = \frac{1}{N} {\sum }_{k = 0}^{N} ( {R}_{xk} - {S}_{xk} ) \\ Δ y = \frac{1}{N} {\sum }_{k = 0}^{N} ( {R}_{yk } - {S}_{yk} ) \qquad ( 2 )$$

In the present embodiment, in Equation (2), the latest image frame may be set as the first image frame, and the immediately previous image frame may be set as the second image frame. In another embodiment, the immediately previous image frame may be set as the first image frame, and the latest image frame may be set as the second image frame.

When calculation of the scroll amount is completed, the scroll amount calculation unit 640 notifies the snapshot history information processing unit 628 of the calculated scroll amount.

The snapshot history information processing unit 628 changes the drawn image configuration information using the scroll amount calculated by the scroll amount calculation unit 640 and stores the changed drawn image configuration information in a snapshot information storage unit 618 or deletes the drawn image configuration information stored in the snapshot information storage unit 618. The snapshot history information processing unit 628 registers the drawn image configuration information changed according to the scroll amount and the image frame stored in the snapshot information storage unit 618 so as to be associated with each other in the snapshot history information table in the snapshot history information processing unit 628.

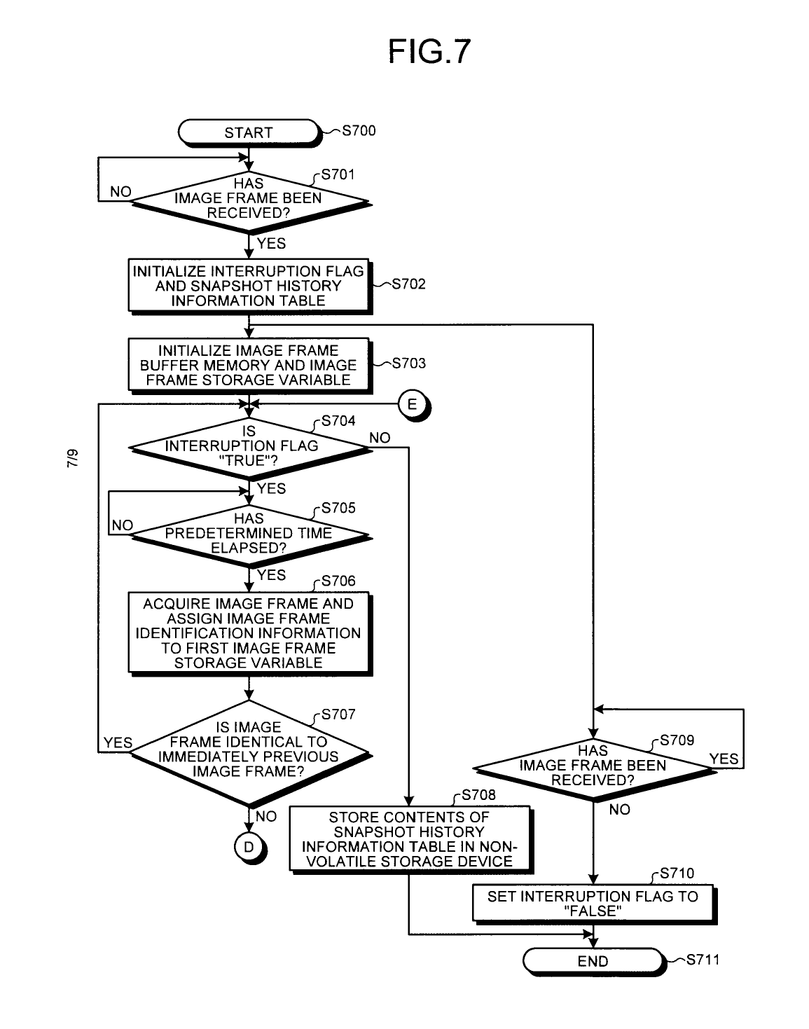

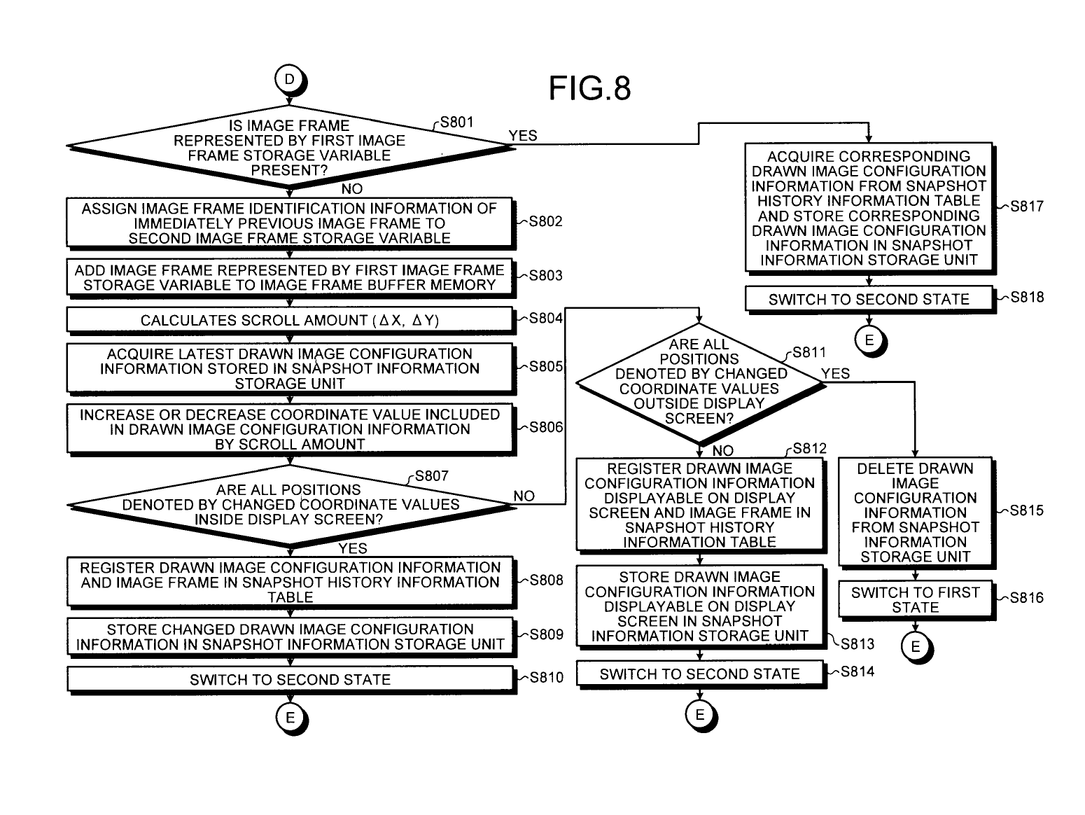

FIGS. 7 and 8 are flowcharts illustrating a process executed by the image display device illustrated in FIG. 6. The process executed by the image display device will be described below with reference to FIGS. 7 and 8. Step S700 to Step S711 of the process illustrated in FIG. 7 are the same as Step S300 to Step S308 and Step S317 to Step S319 of the process illustrated in FIG. 3, and thus a redundant description will not be repeated.

The process of FIG. 8 corresponds to the process of Step S309 to Step S316 illustrated in FIG. 3 and is executed when the image frame judgment unit 626 judges that two consecutive image frames are different from each other. In Step S801, the snapshot history information processing unit 628 refers to the snapshot history information table of the snapshot history information database 630 to judge whether or not there is an image frame identical to a latest image frame denoted by image frame identification information assigned to a first image frame storage variable in Step S706.

When it is judged that there is the image frame identical to the image frame designated by the first image frame storage variable (Yes in Step S801), the process branches to Step S817. In Step S817, the snapshot history information processing unit 628 refers to the snapshot history information table to acquire the drawn image configuration information associated with the image frame identification information of the image frame judged as being identical to the image frame designated by the first image frame storage variable, and stores the drawn image configuration information in the snapshot information storage unit 618. Thus, when the background image previously displayed on the image display device is displayed again, the drawn image associated with the background image can be displayed again along with the background image. In Step S818, the scroll amount calculation unit 640 causes a mode switching control unit 638 to switch the operation mode of the image display device 600 to the second state.

Meanwhile, when it is judged that there is no image frame that is identical to the image frame designated by the first image frame storage variable (No in Step S801), the process branches to Step S802. In Step S802, the snapshot history information processing unit 628 assigns image frame identification information denoting an image frame lastly stored in the image frame buffer memory 624 to a second image frame storage variable. In Step S803, the snapshot history information processing unit 628 additionally puts the image frame identification information designated by the first image frame storage variable and the image frame denoted by the image frame identification information into the image frame buffer memory 624 through the image frame management unit 622.

In Step S804, the scroll amount calculation unit 640 calculates the scroll amount (Δx, Δy) of the latest image frame using the image frame designated by the first image frame storage variable and the image fame designated by the second image frame storage variable and notifies the snapshot history information processing unit 628 of the calculated scroll amount (Δx, Δy). In Step S805, the snapshot history information processing unit 628 acquires the latest drawn image configuration information retained in the snapshot information storage unit 618. In Step S806, the coordinate value in the drawn image configuration information is increased or decreased by the scroll amount (Δx, Δy). In Step S807, the snapshot history information processing unit 628 judges whether or not all positions denoted by coordinate values in the drawn image configuration information changed by increasing or decreasing by the scroll amount are inside a display screen area of the image display device 600.

When it is judged that all positions denoted by coordinate values in the changed drawn image configuration information are inside the display screen area (Yes in Step S807), the process branches to Step S808. In Step S808, the snapshot history information processing unit 628 registers the changed drawn image configuration information in the snapshot history information table so that the changed drawn image configuration information is associated with the image frame identification information of the image frame designated by the first image frame storage variable. In Step S809, the snapshot history information processing unit 628 stores the changed drawn image configuration information in the snapshot information storage unit 618. Thus, the drawn image can be displayed in conjunction with the background image moved by scrolling.

In Step S810, the snapshot history information processing unit 628 causes the mode switching control unit 638 to switch the operation mode of the image display device 600 to the second state. Thereafter, Step S704 of FIG. 7 is executed.

Meanwhile, when it is judged that at least part of the positions denoted by the coordinate values in the changed drawn image configuration information is not inside the display screen area (No in Step S807), the process branches to Step S811. In Step S811, the snapshot history information processing unit 628 judges whether all of the positions denoted by the coordinate values in the changed drawn image configuration information are outside the display screen area. In the present embodiment, when any one of the x coordinate and the y coordinate of one coordinate point configuring the drawn image is outside the display screen area, the one coordinate point is judged as being present outside the display screen area.

When it is judged that not all of the positions denoted by the coordinate values of the changed drawn image configuration information are outside the display screen area, that is, when it is judged that at least part of the positions denoted by the coordinate values is inside the display screen area (No in Step S811), the process branches to Step S812. In Step S812, the snapshot history information processing unit 628 extracts the drawn image configuration information on a drawn image displayable inside the display area of a display unit 650 from the changed drawn image configuration information, and registers the extracted drawn image configuration information and the image frame identification information of the image frame designated by the first image frame storage variable to be associated with each other in the snapshot history information table. In Step S813, the snapshot history information processing unit 628 stores the drawn image configuration information, that is on the drawn image displayable inside the display area of the display unit 650, extracted in Step S812 in the snapshot information storage unit 618. Thus, when the drawn image is displayed in conjunction with the background image moved by scrolling, it is possible to appropriately display the drawn image displayable inside the display screen area of the image display device.

In Step S814, the snapshot history information processing unit 628 causes the mode switching control unit 638 to switch the operation mode of the image display device 600 to the second state. Thereafter, Step S704 in FIG. 7 is executed.

Meanwhile, when it is judged that all of the positions denoted by the coordinate values in the changed drawn image configuration information are outside the display screen area (Yes in Step S811), the process branches to Step S815. In Step S815, the snapshot history information processing unit 628 deletes the drawn image configuration information stored in the snapshot information storage unit 618. In Step S816, the snapshot history information processing unit 628 causes the mode switching control unit 638 to switch the operation mode of the image display device 600 to the first state. Thereafter, Step S704 in FIG. 7 is executed.

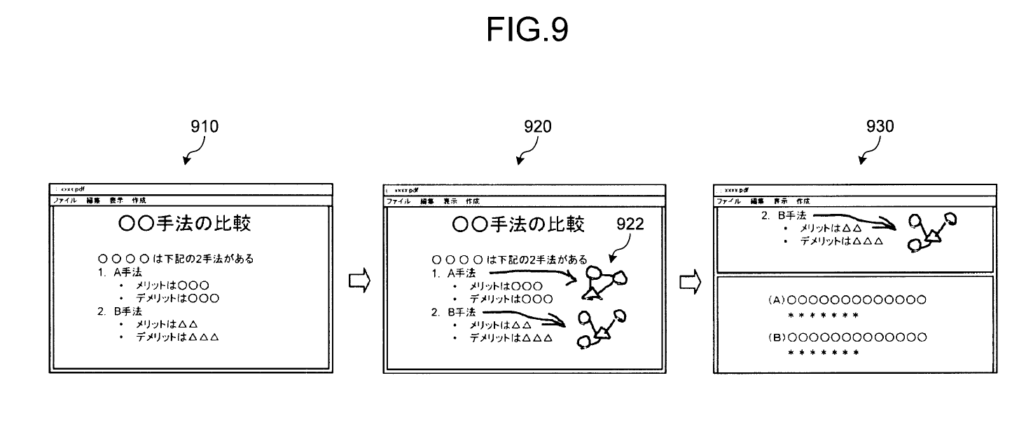

FIG. 9 is a diagram illustrating an embodiment of an image displayed on an image display device. An image 910 represents an image frame in which a drawn image is not written. The image 910 is the same as an image frame displayed on the user PC that provides the image frame. An image 920 represents an image in which a drawn image 922 is additionally written on the image 910 on the image display device. An image 930 represents an image in which the image 920 on the display device moves upward as the image frame on the user PC is upward scrolled. In the present embodiment, as illustrated in FIG. 9, the drawn image 922 can be moved in conjunction with a change in the image frame.

According to the present invention, it is possible to provide an image display device, an image display system, an image display method, a program, and a recording medium in which a drawn image drawn on a background image displayed in the past can be displayed again, and a drawn image can be displayed in conjunction with movement of a background image.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image display device that displays at lease one image frame, comprising:
a receiving unit that receives the at least one image frame from an image frame provision device that provides the at least one image frame;
a display unit that displays one of the at least one image frame that is received by the receiving unit;
a touch panel that detects a contact position on the display unit, which configures configuration information of at least one drawn image to be superimposedly drawn on the at lease one image frame;
a database in which the at least one image frame and the configuration information of the at least one drawn image to be displayed on the display unit are registered to be associated with each other;
a judging unit that refers to the database to judge whether or not an image frame that is identical to one of the at least one image frame received from the image frame provision device is present in the database,
wherein the judging unit refers to the database to cause the display unit to display at least one of the at least one drawn image represented by a part of the configuration information associated with an image frame judged as being identical to a received one of the at least one image frame.

2. The image display device according to claim 1, further comprising:
a calculating unit that calculates a movement amount between two consecutive ones of the at least one image frame received from the image frame provision device,
wherein the judging unit generates a changed part of the configuration information obtained by changing a part of the configuration information representing at least one of the at least one drawn image, which is configured from detection result by the touch panel on corresponding one of the at least one image frame, such that the at least one of the at least one drawn image is moved by the movement amount, and thereby causes the display unit to display the at least one of the at least one drawn image moved by the movement amount.

3. The image display device according to claim 2,
wherein the judging unit extracts an extracted part of the configuration information representing at least one of the at least one drawn image, which is displayable inside a display area of the display unit, from the changed part of the configuration information, and thereby causes the display unit to display the at least one of the at least one drawn image represented by the extracted part of the configuration information.

4. The image display device according to claim 1, further comprising:
a drawing processing unit that acquires attribute information of the at least one drawn image,
wherein the configuration information includes the attribute information of the at least one drawn image.

5. The image display device according to claim 4,
wherein the attribute information includes the display color of the at least one drawn image and the thickness of a line segment of the at least one drawn image.

6. An image display system, comprising:
an image display device that displays at least one image frame; and
an image frame provision device that provides the image display device with the at least one image frame,
wherein the image display device includes
a receiving unit that receives the at least one image frame from the image frame provision device,
a display unit that displays one of the at least one image frame that is received by the receiving unit,
a touch panel that detects a contact position on the display unit, which configures configuration information of at least one drawn image to be superimposedly drawn on the at lease one image frame,
a database in which the at least one image frame and the configuration information of the at least one drawn image to be displayed on the display unit are registered to be associated with each other, and
a judging unit that refers to the database to judge whether or not an image frame identical to one of the at least one image frame received from the image frame provision device is present in the database, and
wherein the judging unit refers to the database to cause the display unit to display at least one of the at least one drawn image represented by a part of the configuration information associated with an image frame judged as being identical to a received one of the at least one image frame.

7. The image display system according to claim 6, wherein
the image display device further comprises a calculating unit that calculates a movement amount between two consecutive ones of the at least one image frame received from the image frame provision device, and
the judging unit generates changed part of the configuration information obtained by changing a part of the configuration information representing at least one of the at least one drawn image, which is configured from detection result by the touch panel on corresponding one of the at least one image frame, such that the at least one of the at least one drawn image is moved by the movement amount, and thereby causes the display unit to display the at least one of the at least one drawn image moved by the movement amount.

8. The image display system according to claim 7,
wherein the judging unit extracts an extracted part of the configuration information representing at least one of the at least one drawn image, which is displayable inside a display area of the display unit, from the changed part of the configuration information, and thereby causes the display unit to display the at least one of the at least one drawn image represented by the extracted part of the configuration information.

9. An image display method executed by an image display device that displays at least one image frame, comprising:
receiving, by the image display device, the at least one image frame from an image frame provision device that provides the at least one image frame; and
judging, by the image display device, whether or not there is an image frame identical to one of the at least one image frame received from the image frame provision device by referring to a database in which the at least one image frame to be displayed on a display unit of the image display device and configuration information of at least one drawn image to be superimposedly drawn on the at least one image frame are registered to be associated with each other,
wherein the judging includes referring to the database to cause the display unit to display at least one of the at least one drawn image represented by a part of the configuration information associated with an image frame judged as being identical to a received one of the at least one image frame.

10. The image display method according to claim 9, further comprising:
calculating, by the image display device, a movement amount between two consecutive ones of the at least one image frame received from the image frame provision device;
detecting, by the image display device, a contact position on the display unit, which configures a part of the configuration information representing at lease one of the at least one drawn image on corresponding one of the at least one image frame; and
generating, by the image display device, a changed part of the configuration information obtained by changing the part of the configuration information such that the at least one of the at least one drawn image is moved by the movement amount and thereby causes the display unit to display the at least one of the at least one drawn image moved by the movement amount.

11. The image display method according to claim 10, further comprising,
extracting, by the image display device, an extracted part of the configuration information representing at least one of the at least one drawn image, which is displayable inside a display area of the display unit, from the changed part of the configuration information, and thereby causing the display unit to display the at least one of the at least one drawn image represented by the extracted part of the configuration information.
